(19) United States
(12) Patent Application Publication
(10) Pub. No.: US 2025/0256348 A1
(43) Pub. Date: Aug. 14, 2025

(54) System for Printing Metal Parts by Liquid Metal Deposition

(71) Applicant: M AEROSPACE RTC INC., Austin, TX (US)

(72) Inventors: Juan Carlos Munguía Castañeda, Austin, TX (US); Luis Angel Rodriguez Mayen, Mexicali (MX); Miguel Angel Ramírez Hernández, Mexicali (MX)

(21) Appl. No.: 18/438,991

(22) Filed: Feb. 12, 2024

(51) Int. Cl. B23K 13/01; B23K 37/02; B33Y 30/00; B33Y 70/00

(52) U.S. Cl. CPC B23K 13/01; B22F 12/53; B23K 37/0258; B33Y 30/00; B33Y 50/02; B33Y 70/00

(57) ABSTRACT

A system for printing metal parts by liquid metal deposition, with improved control of the printing process progress, which allows large-sized metal parts to be obtained without stress concentration, and which also homogenizes the metallic microstructure of the formed parts.

### BACKGROUND

### 1. Technical Field

The present disclosure relates to a system for printing metal parts by liquid metal deposition, and more particularly relates to an automated system for printing metal parts of any suitable configuration by deposition of liquid metal drops on a large format work surface, which allows obtaining large metal pieces without having effort concentration, and also homogenizing the metallic microstructure of the pieces. Likewise, the present disclosure relates to a system for printing metal parts by liquid metal deposition, with improved control of the wire advance and means to improve control of the casting temperature.

### 2. Technical Considerations

The manufacturing of metal components is one of the materials production fields that has had the least number of improvements over recent years, since the conventional production processes of these elements such as casting, forging, extrusion, and machining, have remained almost unchanged to this day. However, due to the growing demand for specific components on demand, with increasingly complex configurations, these conventional production processes have not been sufficient to meet the great demand for specialized metal components. Additionally, with the advancement of technology, new challenges have arisen regarding how to obtain metal parts with increasingly complex configurations, which are difficult to obtain in single-step processes such as casting and extrusion; or that become complex to carry out due to multi-stage processes such as machining and forging.

For this reason, specific processes have had to be designed to obtain metal parts with a complex geometry, which allow specialized components to be produced quickly on demand. One of the processes for forming metal parts that has proven to be most efficient in terms of time and use of raw materials has been the printing of metal parts by liquid metal deposition. Said liquid metal deposition printing process is based on the consecutive deposition of small droplets of liquid metal on a work substrate. The printing process, therefore, forms the metal piece by adding layers of material based on the interpretation of movements based on a printing matrix.

Metal deposition printing technology has the advantage of allowing the creation of metal parts with complex geometries that could hardly be obtained by other metal part forming processes. However, it has the drawback of requiring both casting control mechanisms and material dispersion, based on complex heating and material output control systems. Furthermore, the size of the pieces obtained is limited by the material dispersion speed, as well as the structural limitations of the components intended for the movement of the printing head.

In order to avoid the limitations of the equipment for printing metal parts, printing heads have been developed that improve both the control of temperature and the delivery of molten material, such as the one described in Patent Application DE102016224047A1, which describes a print head for 3D printing of metals, which has a casting chamber with resistors embedded on its outside. Said head has a wire supply system that allows the material to be melted to be introduced into the casting chamber in a controlled manner, and an independent material output control system. Said head has a material outlet locking system, formed by structures that block the outlet of the dispersion nozzle by means of an actuator that raises a locking plug. However, said locking system has the drawback of requiring multiple work cycles to adequately control the material dispersion, so the constant lifting and falling movement of the locking plug decreases considerably the speed of the printing process. Additionally, due to the complexity of the locking system, it is necessary to restrict the effective movement area of the head, to avoid a poor material delivery process.

On the other hand, Patent Application US20180304369A1 describes a printing head that uses a metal wire, which has an advance system controlled by a pair of guide rollers. This system advances the wire and forces it into a cylindrical casting chamber, in which the wire is melted and subsequently released through a nozzle. The system controls the material dispersion only with the wire advance system, so there is no precise control of the internal pressure of the molten material inside the casting chamber. Furthermore, since only the advance of the wire is used to control the material dispersion, it is difficult to homogenize the microstructure of the formed part, since regions with poor homogeneity are produced caused by differences in temperature and dispersion pressure. Furthermore, it must be considered that the head nozzle must be in contact with the receiving surface at all times since there are no ways to control the exit of the molten material.

As can be seen from the above, the equipment for printing metal parts available is only useful for printing small-format metal parts, since they have a small effective printing area, which is restricted by the limitations of the structures intended for the movement of the print head. Likewise, the effective printing area cannot be scaled since the structures responsible for printing could cause that the head operation cause stress concentration in the metal parts during their formation. Furthermore, the equipment available for printing metal parts by liquid metal deposition has poor control of the working pressure of the casting chamber, which is why they require material output control mechanisms, which limit the printing speed.

In view of the previous problem, there is a need to provide a system for printing metal parts by liquid metal deposition that can produce metal parts of large dimensions, such as for example greater than 3.048 meters (10 feet), preferably up to 9.144 meters (30 feet), without causing stress concentration in the pieces during their formation. Likewise, there is a need to provide a system for printing metal parts by liquid metal deposition that can work at high speeds without affecting the mechanical properties of the printed parts, in such a way that parts with a high homogeneity of its metallic microstructure are obtained.

### SUMMARY

In order to overcome the limitations of the available equipment for printing metal parts by liquid metal deposition processes, the object of the present disclosure is to provide a system for printing metal parts by liquid metal deposition, which works at high speeds without causing stress concentration in the parts.

Another object of the present disclosure is to provide a system for printing metal parts by liquid metal deposition, with which a high homogeneity of the metallic microstructure of the formed parts is obtained.

Another object of the present disclosure is to provide a system for printing metal parts by liquid metal deposition, which allows for more efficient control of the temperature of the chamber where the casting process will be carried out.

An additional objective of the present disclosure is to provide a system for printing metal parts with an improved advance mechanism that allows more precise control of the advance of the metal wire used for printing the metal parts.

It is also an object of the present disclosure to provide a system for printing metal parts by liquid metal deposition, with a degree of freedom of movement sufficient to be able to obtain large metal parts.

Another objective of the present disclosure is to provide a system for printing metal parts by liquid metal deposition, which allows obtaining metal parts with good structural behavior, and that also have sufficient mechanical resistance to avoid fractures during use.

The aforementioned objectives, as well as others and the advantages of the present disclosure, will become apparent from the following detailed description thereof.

### BRIEF DESCRIPTION OF THE DRAWINGS

The terms Fig., Figs., Figure, and Figures are used interchangeably in the specification to refer to the corresponding figures in the drawings.

FIG. 1 is a perspective view of the system for printing metal parts by liquid metal deposition according to the present disclosure; and

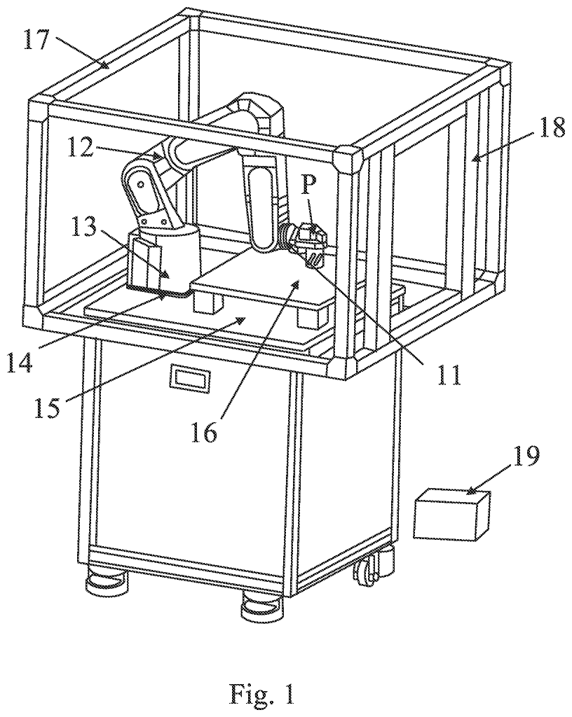

FIG. 2 is a perspective view of a close-up of the printing head (P) of the system for printing metal parts by liquid metal deposition according to the present disclosure.

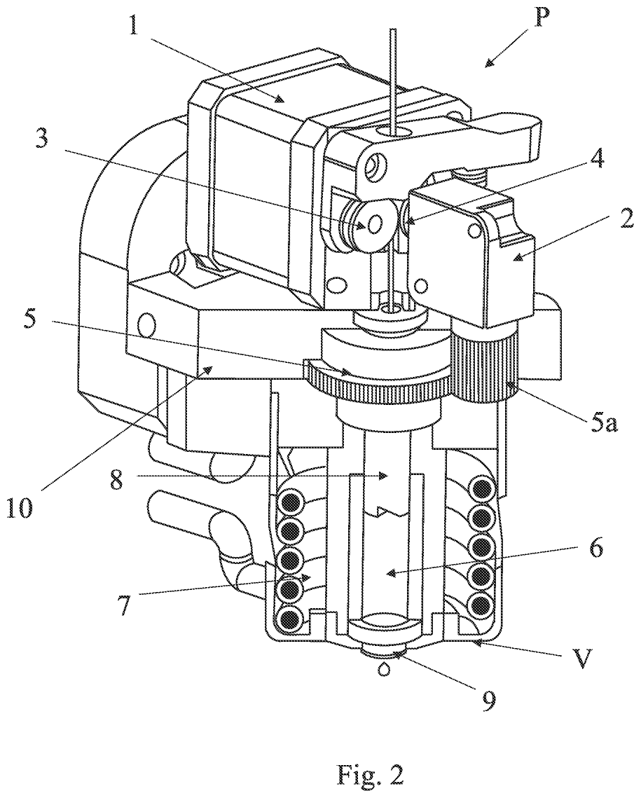

### DETAILED DESCRIPTION

The present disclosure provides a system for printing metal parts by liquid metal deposition, which can work at high speeds without causing stress concentration in the parts during their formation and which also allows obtaining a high homogeneity of the metallic microstructure in the parts during manufacturing. Likewise, the system for printing metal parts by liquid metal deposition of the present disclosure allows obtaining metal parts with good structural behavior, and also have sufficient mechanical resistance to avoid fractures during use. Additionally, the system for printing metal parts by liquid metal deposition of the present disclosure has a degree of freedom of movement large enough to be able to obtain metal parts with a complex shape and large format. Therefore, the system of the present disclosure can produce metal parts that are not limited by the shape of the receiving surface on which they are produced, such that it is possible to produce metal parts up to 9.144 meters (30 feet) long.

The system for printing metal parts by liquid metal deposition of the present disclosure reduces the formation of contaminant films on the parts during printing, since it uses a casting head with improved advance and heating mechanisms, which allows a more precise control of the casting temperature and the advance of the metal wire used to produce the parts.

To achieve the advantages described above, the system for printing metal parts by liquid metal deposition of includes:
a feed motor (1) with a shaft coupled to a gearbox (2); a first feed roller (3) arranged on the axis between the feed motor (1) and the gearbox (2), said feed roller (3) being coordinated with a second feed roller (4), in such a way that said first and second feed rollers (3 and 4) control the advance of a metal wire preferably fed from a coil; a thrust gear (5) with a central perforation for the passage of the metal wire, said thrust gear (5) being connected to the gearbox (2) by means of a transmission gear (5a), in such a way that said thrust gear (5) coordinates its rotation with the advance of the metal wire;
a casting chamber (6) arranged below the thrust gear (5), which receives inside the metal wire that has passed through the central perforation of said thrust gear (5); an induction coil (7) arranged on the outside of the casting chamber (6), which causes a magnetic field to occur inside the casting chamber (6) with sufficient power to melt the metal wire contained inside, said power preferably being between 50 kW and 1000 kW, such that said casting chamber (6) is filled with molten metal; a ventilation chamber (V), adapted to contain and support the casting chamber (6) and the induction coil (7) inside it, said ventilation chamber (V) having inclined ventilation slots that generate an air flow sufficient to dissipate the heat emitted by the casting chamber (6) and by the operation of the induction coil (7); a drill type pusher (8), connected to the lower part of the thrust gear (5), which has a plurality of inclined surfaces that when rotating press the molten metal contained within the casting chamber (6), to control the advance of the molten metal towards the bottom of said casting chamber (6); a nozzle (9) arranged in the bottom of the casting chamber (6), which allows the controlled exit of the molten metal that is pushed by the rotation of the drill-type pusher (8), in such a way that said nozzle (9)) deliver drops of molten metal that solidify upon contact with a work surface, preferably the speed of delivery of said drops of metal being sufficient to disperse a volume of molten metal of between 1 and 3 square inches per minute;
a support (10) adapted to receive the feed motor (1), the thrust gear (5), the casting chamber (6) and the ventilation chamber (V), in such a way that a printing head (P) is formed, said support (10) having means for securing it to an end plate (11) of a robotic arm (12) having at least 6 articulation points, such that the printing head (P) has movement in any of the “X”, “Y” and “Z” directions to modify the region and drop angle of the molten metal drops; a support plate (13) adapted to receive the base of the robotic arm (12), said support plate (13) being arranged on a support base (14) to avoid vibrations during movements of the robotic arm (12);
a worktable (15), which receives the support base (14) on its surface, said worktable (15) having a surface area sufficient to cover the movement area in the “X” and “Z” directions of the robotic arm (12); a work surface (16), which is detachably placed on the worktable (15), which receives the drops of molten metal from the nozzle (9) for printing the metal part; a receiving frame (17), arranged on the worktable (15), which has a sufficient height to allow movement in the “Y” direction of the robotic arm (12), said receiving frame (17) being covered by resistant walls such as tempered glass panels, plexiglass, acrylic or any combination thereof, or other material with similar characteristics; and at least one access door (18) arranged in one of the walls of the receiving frame (17), in such a way that a closed enclosure is formed between the resistant walls and the worktable (15), when said access door (18) is in a closed position, thus preventing the passage of external materials during the printing process of the metal parts; and
a programmable controller (19), arranged in a location outside the receiving frame (17), configured to:
send instructions that coordinate the movement of the robotic arm (12), so that said robotic arm (12) positions the printing head (P) in specific regions on the work surface (16) based on a vectorized plane of the part metallic to be printed;
prevent the robotic arm (12) from colliding with the internal surface of the resistant walls of the receiving frame (17); and
receive a feedback signal from the feed motor (1), through the encoding of an amperage variation respect to the predetermined working amperage for said feed motor (1), to control the pressure inside the casting chamber (6), in such a way that a variation in the predetermined working amperage of the feed motor (1) represents an increase in pressure within the casting chamber (6), which is controlled by stopping the advance of the metal wire, until it returns to the predetermined working amperage.

The system for printing metal parts by liquid metal deposition described above allows the printing of large-format metal parts, since it is not limited by the worktable dimensions, as the printing head (P) moves in any of the “X”, “Y” and “Z” directions, the only limitation of said movement being the maximum extension of the robotic arm (12). Additionally, since the printing head (P) does not require complex heating and cooling systems, the control of the casting temperature is improved, so that it is possible to obtain better control of printing of metal parts.

Preferably, the casting chamber (6), the drill-type pusher (8) and the nozzle (9) of the system described above are made of a heat and deformation resistant material, such as, for example, a ceramic material. Said ceramic material in a preferred embodiment of the present disclosure is a ceramic with a crystalline structure such as alumina (Al₂O₃), such that said casting chamber (6), the drill type pusher (8) and the nozzle (9) have a hardness of 9 on the Mohs scale, a compressive strength of up to 3000 mega pascals (435113 PSI), and a thermal resistance of up to 2038° C. (3700° F.). Therefore, the casting chamber (6) of the printing head (P) of the system for printing metal parts by liquid metal deposition of the present disclosure is adapted to melt wires of metallic materials with high melting points, such as metallic wires of titanium, aluminum, INCONEL 625, INCONEL 618, carbon steel, stainless steel, and any other non-refractory metallic material wire with similar characteristics.

In a non-limiting embodiment of the present disclosure, the work surface (16) has a length in either of the “X” or “Z” directions of at least 9.144 meters (30 feet), in such a way that monobloc metal parts with a length of up to 9.144 meters (30 feet) can be printed.

In a non-limiting embodiment of the present disclosure, the worktable (15) has means to facilitate its movement and leveling, such as wheels with a lifting and locking mechanism that allow modifying its extension distance respect to the base of the worktable (15).

The present disclosure has been described according to a non-limiting embodiment; however, it will be apparent to a person skilled in the art that modifications may be made to the disclosure, without departing from the spirit and scope thereof.

1. A system for printing metal parts by liquid metal deposition, comprising:
a feed motor with a shaft coupled to a gearbox; a first feed roller arranged on the axis between the feed motor and the gearbox, said feed roller being coordinated with a second feed roller, in such a way that said first and second feed rollers control the advance of a metal wire; a thrust gear with a central perforation for the passage of the metal wire, said thrust gear being connected to the gearbox by means of a transmission gear, in such a way that said thrust gear coordinates its rotation with the advance of the metal wire;
a casting chamber arranged below the thrust gear, which receives inside the metal wire that has passed through the central perforation of said thrust gear; an induction coil arranged on the outside of the casting chamber, which causes a magnetic field to occur inside the casting chamber with sufficient power to melt the metal wire contained inside, such that said casting chamber is filled with molten metal; a ventilation chamber, adapted to contain and support the casting chamber and the induction coil inside it, said ventilation chamber having inclined ventilation slots that generate an air flow sufficient to dissipate the heat emitted by the casting chamber and by the operation of the induction coil; a drill type pusher, connected to the lower part of the thrust gear, which has a plurality of inclined surfaces that when rotating press the molten metal contained within the casting chamber, to control the advance of the molten metal towards the bottom of said casting chamber; a nozzle arranged in the bottom of the casting chamber, which allows the controlled exit of the molten metal that is pushed by the rotation of the drill-type pusher, in such a way that said nozzle) deliver drops of molten metal that solidify upon contact with a work surface;
a support adapted to receive the feed motor, the thrust gear, the casting chamber and the ventilation chamber, in such a way that a printing head is formed, said support having means for securing it to an end plate of a robotic arm, in such a way that the printing head has movement in any of the “X”, “Y” and “Z” directions to modify the region and the drop angle of the molten metal drops; a support plate adapted to receive the robotic arm base, said support plate being arranged on a support base to avoid vibrations during movements of the robotic arm;
a worktable, which receives the support base (14) on its surface, said worktable having a surface area sufficient to cover the movement area in the “X” and “Z” directions of the robotic arm; a work surface, which is detachably placed on the worktable, which receives the drops of molten metal from the nozzle for printing the metal part; a receiving frame, arranged on the worktable, which has a sufficient height to allow movement in the “Y” direction of the robotic arm, said receiving frame being covered by resistant walls; and at least one access door arranged in one of the walls of the receiving frame, in such a way that a closed enclosure is formed between the resistant walls and the worktable, when said access door is in a closed position, thus preventing the passage of external materials during the printing process of the metal parts; and
a programmable controller, arranged in a location outside the receiving frame, configured to:
send instructions that coordinate the movement of the robotic arm, so that it positions the printing head in specific regions on the work surface based on a vectorized plane of the metal part to be printed;
prevent the robotic arm from colliding with the internal surface of the resistant walls of the receiving frame; and
receive a feedback signal from the feed motor, through the encoding of a amperage variation respect to the predetermined working amperage for said feed motor, to control the pressure inside the casting chamber, in such a way that a variation in the predetermined working amperage of the feed motor represents an increase in pressure within the casting chamber, which is controlled by stopping the advance of the metal wire, until it returns to the predetermined working amperage.

2. The system according to claim 1, wherein the delivery speed of the molten metal drops from the nozzle is between 1 and 3 square inches per minute.

3. The system according to claim 1, wherein the robotic arm has at least 6 articulation points.

4. The system according to claim 1, wherein the resistant walls of the receiving frame are at least one of the following: tempered glass panels, plexiglass, acrylic, or any combination thereof.

5. The system according to claim 1, wherein the casting chamber, the drill-type pusher and the nozzle of the system are made of a heat and deformation resistant material.

6. The system according to claim 5, wherein the heat and deformation resistant material is a ceramic material.

7. The system according to claim 6, wherein the ceramic material is alumina (Al₂O₃).

8. The system according to claim 1, wherein the casting chamber, the drill-type pusher and the nozzle have a hardness of 9 on the Mohs scale, a compressive strength of 3000 mega pascals (435113 PSI), and a thermal resistance of 2038° C. (3700° F.).

9. The system according to claim 1, wherein the working power of the induction coil is between 50 kW and 1000 kW.

10. The system according to claim 1, wherein the work surface has a length in any of the “X” or “Z” directions of at least 9.144 meters (30 feet).

11. The system according to claim 1, wherein the worktable has means to facilitate its movement and leveling.

12. The system according to claim 11, wherein the means to facilitate its movement and leveling comprises wheels with a lifting and locking mechanism that allow their extension distance to be modified respect to the base of the worktable.

13. The system according to claim 1, wherein the casting chamber of the printing head is adapted to melt wires of metallic materials with high melting points, said wires being of metallic materials selected from the group consisting of wires of titanium, aluminum, INCONEL 625, INCONEL 618, carbon steel, stainless steel, and any other non-refractory metallic material wire with similar characteristics.
